(19) United States
(12) Patent Application Publication
(10) Pub. No.: US 2016/0109339 A1
(43) Pub. Date: Apr. 21, 2016

(54) COMPOSITIONS AND METHODS FOR REMOVING PETROLEUM OIL FROM SOIL

(71) Applicants: Raul CUERO RENGIFO, Cypress, TX (US); Jhon Henry TRUJILLO MONTENEGRO, Cali (CO); Jennifer Melissa RUSSI CASTILLO, Manizales (CO); Mauricio CASTILLO PALACIOS, Manizales (CO); INTERNATIONAL PARK OF CREATIVITY, Bogota (CO)

(72) Inventors: Raul CUERO RENGIFO, Cypress, TX (US); Jhon Henry TRUJILLO MONTENEGRO, Cali (CO); Jennifer Melissa RUSSI CASTILLO, Manizales (CO); Mauricio CASTILLO PALACIOS, Manizales (CO)

(73) Assignee: INTERNATIONAL PARK OF CREATIVITY, Bogota (CO)

(21) Appl. No.: 14/892,226

(22) PCT Filed: May 21, 2014
(86) PCT No.: PCT/US14/38888

§ 371 Date: Nov. 19, 2015

Related U.S. Application Data
(60) Provisional application No. 61/826,242, filed on May 22, 2013.

(51) Int. Cl. G01N 1/40; C10G 1/00

(52) U.S. Cl. CPC G01N 1/4044; C10G 1/00

(57) ABSTRACT

Described herein are compositions and methods for effectively removing from soil samples. By isolating the oil from the soil sample, it is possible to accurately evaluate the different properties of the oil in the sample.

### CROSS REFERENCE TO RELATED APPLICATION

This application claims priority upon U.S. Provisional Application Ser. No. 61/826,242, filed May 22, 2013. The application is hereby incorporated by reference in its entirety for all of its teachings.

### BACKGROUND

Oil exploration is a process which is not only costly and uncertain but also time-consuming, technology-intensive, and labor-intensive. Typically, a large capital investment is required. Many oil exploration techniques involve targeting traces of petroleum which are believed to be connected to, or geographically near, larger petroleum reserves.

The removal of oil from a soil sample so that the oil can be further tested is not a trivial process. Depending upon the soil sample, several impurities can be present that can provide false positives and negatives. Moreover, due to the evolution of soil over extensive periods of time, the oil can be impregnated with different components from the soil depending upon the geographic location of the soil. It would therefore be desirable to develop an improved method for isolating oil from a soil sample so that the oil can be further evaluated and tested.

### SUMMARY

Described herein are compositions and methods for effectively removing oil from soil samples. By isolating the oil from the soil sample, it is possible to accurately evaluate the different properties of the oil in the sample. These and other aspects, features, and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows an exemplary reactor for sediment conditions used in a controlled-environment simulation.

### DETAILED DESCRIPTION

The present invention may be understood more readily by reference to the following detailed description of the invention taken in connection with the accompanying drawing figures, which form a part of this disclosure. It is to be understood that this invention is not limited to specific devices, compounds, compositions, methods, conditions, or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

In this specification and in the claims that follow, reference will be made to a number of terms that shall be defined to have the following meanings:

It must be noted that, as used in the specification and the appended claims, the singular forms “a,” “an,” and “the” include plural referents unless the context clearly dictates otherwise. Thus, for example, reference to “a polysaccharide” includes two or more polysaccharides, and the like.

“Optional” or “optionally” means that the subsequently described event or circumstance can or cannot occur, and that the description includes instances where the event or circumstance occurs and instances where it does not.

As used herein, the term “about” is used to provide flexibility to a numerical range endpoint by providing that a given value may be “a little above” or “a little below” the endpoint without affecting the desired result.

As used herein, “petroleum” or “crude oil” or “oil” refers to a naturally-occurring fossil fuel that includes hydrocarbons and/or other organic molecules, optionally including sulfur compounds, and most often found beneath the Earth's surface. In some cases, petroleum is also detectable in surface-level soil. Petroleum and/or crude oil can be refined into multiple other products including gasoline and other fuels, as well as asphalt, components of plastics, etc.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group, without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range was explicitly recited. As an illustration, a numerical range of “about 1 to about 5” should be interpreted to include not only the explicitly recited values of about 1 to about 5, but also to include individual values and sub-ranges within the indicated range. Thus, included in this numerical range are individual values such as 2, 3, and 4, and sub ranges such as from 1-3, from 2-4, and from 3-5, etc., as well as 1, 2, 3, 4, and 5, individually. The same principle applies to ranges reciting only one numerical value as a minimum or a maximum. Furthermore, such an interpretation should apply regardless of the breadth of the range or the characteristics being described.

Disclosed are materials and components that can be used for, can be used in conjunction with, can be used in preparation for, or are products of the disclosed compositions and methods. These and other materials are disclosed herein, and it is understood that when combinations, subsets, interactions, groups, etc. of these materials are disclosed, that while specific reference of each various individual and collective combination and permutation of these compounds may not be explicitly disclosed, each is specifically contemplated and described herein. For example, if a grade of petroleum is disclosed and discussed and a number of different transition metals are discussed, each and every combination and permutation of petroleum grade and transition metal that is possible is specifically contemplated unless specifically indicated to the contrary. For example, if a class of molecules A, B, and C are disclosed, as well as a class of molecules D, E, and F, and an example of a combination A+D is disclosed, then even if each is not individually recited, each is individually and collectively contemplated. Thus, in this example, each of the combinations A+E, A+F, B+D, B+E, B+F, C+D, C+E, and C+F, are specifically contemplated and should be considered disclosed from disclosure of A, B, and C; D, E, and F; and the example combination of A+D. Likewise, any subset or combination of these is also specifically contemplated and disclosed. Thus, for example, the sub-group of A+E, B+F, and C+E is specifically contemplated and should be considered disclosed from disclosure of A, B, and C; D, E, and F; and the example combination of A+D. This concept applies to all aspects of this disclosure including, but not limited to, steps in methods of making and using the disclosed compositions. Thus, if there are a variety of additional steps that can be performed with any specific embodiment or combination of embodiments of the disclosed methods, and that each such combination is specifically contemplated and should be considered disclosed.

As used herein, the “American Petroleum Institute gravity” or “API gravity” refers to a measure of the density of a petroleum liquid relative to water. API gravity is represented by a number, for example, from about 0 to about 48. The “grade” of a petroleum product is determined based on its API gravity. Heavy crude oil has an API gravity ranging from about 10.0 to about 22.3 and medium crude oil has an API gravity ranging from about 22.3 to about 31.1, while light crude oil has an API gravity higher than 31.1. Extra heavy crude oil is also known, and has an API gravity below about 10.0. API gravity may be calculated from the density and/or specific gravity of a petroleum product by any of the following methods, or by similar or related methods: ASTM D1298, ASTM D4052, ASTM D1250, or ASTM D287.

Described herein are methods for isolating petroleum oil from a soil sample. In one aspect, the method involves:
a. obtaining a sample comprising petroleum oil;
b. contacting the sample with a digestion composition; and
c. filtering the sample in order to isolate a filtrate, wherein the filtrate comprises the petroleum oil.

The soil sample can be any sample that includes petroleum oil. In one aspect, the soil sample can be sandy soil, sludge, silt, clay sediment, sandy sediment, or any combination thereof. The amount of soil sample can vary

After the sample containing the petroleum oil has been obtained, it is contacted with a digestion composition. In general, the soil sample does not require any pre-treatment prior to contact with the digestion composition. Not wishing to be bound by theory, the digestion composition helps prevent the removal of impurities and other components present in the soil sample that can adversely affect the evaluation of the isolated oil. For example, the digestion composition can separate the petroleum oil from other organic impurities such as aromatic compounds. By increasing the purity of the oil that is isolated from the soil sample, it is possible to better evaluate the properties of the oil.

In one aspect, the digestion composition comprises a polysaccharide. As used herein, a “polysaccharide” is a carbohydrate molecule composed of repeated monomer units linked by glycosidic bonds. A polysaccharide may be linear or branched, and may contain only one type of monomer or may contain a mixture of monomers. A polysaccharide can contain substituents including, but not limited to, amino groups, acetyl groups, N-acetyl groups, hydroxyl groups, amide groups, alkylated amino groups, and/or alkylated hydroxyl groups.

In one aspect, the polysaccharide includes chitosan, glucosamine (GlcN), N-acetylglucosamine (NAG), or any combination thereof. Chitosan is generally composed of glucosamine units and N-acetylglucosamine units and can be chemically or enzymatically extracted from chitin, which is a component of arthropod exoskeletons and fungal and microbial cell walls. In certain aspects, the chitosan can be acetylated to a specific degree of acetylation in order to enhance tissue growth during culturing as well as metabolite production. In one aspect, the chitosan is from 60% to about 100%, 70% to 90%, 75% to 85%, or about 80% acetylated. Exemplary procedures for producing and isolating the chitosan are provided in the Examples. In one aspect, chitosan isolated from the shells of crab, shrimp, lobster, and/or krill is useful herein.

The molecular weight of the chitosan can vary, as well. For example, the chitosan comprises about 3, 4, 5, 6, 7, 8, 9, 10, 11, 12, 13, 14, 15, 16, 17, 18, 19, or 20 glucosamine units and/or N-acetylglucosamine units. In another aspect, the chitosan includes 5 to 7 glucosamine units and/or N-acetylglucosamine units. In one aspect, the chitosan is in a solution of water and acetic acid at less than 1% by weight, less than 0.75% by weight, less than 0.50% by weight, less than 0.25% by weight, or less than 0.10% by weight. The amount of polysaccharide present in the digestion composition can vary.

In another aspect, the digestion composition includes a polysaccharide and one or more organic solvents. In one aspect, the organic solvent comprises a linear or branched hydrocarbon, a halogenated hydrocarbon, or a mixture thereof. The selection of the organic solvent varies on the types and amounts of impurities present in the soil sample. For example, the soil sample may have impurities in the form of aromatic compounds. Thus, it would be desirable to remove the petroleum oil from the sample without removing other impurities from the sample that can adversely affect the evaluation of the isolated oil. Examples of linear or branched hydrocarbons include, but are not limited to pentane, hexane, heptane, and branched isomers thereof. Examples of halogenated hydrocarbons include, but are not limited to, chloromethane, dichloromethane, and chloroform. In another aspect, the digestion composition includes chitosan, hexane, and dichloromethane. In one aspect, the digestion composition is from 1% to 10% by volume, 30% to 50% by volume hexane, and 30% to 50% by volume dichloromethane. In one aspect, 1 g to 10 g of soil sample can be contacted with a digestion composition composed of 1.5 to 15 mL of hexane, 1.5 mL to 15 mL of dichloromethane, 100 to 1,000 μL of polysaccharide solution, and 100 to 1,000 μL of dilute nitric acid.

In one aspect, a soil sample of known quantity is obtained and contacted with the digestion composition. The sample is mixed with the digestion composition to ensure that the digestion composition is evenly distributed throughout the sample. After the sample has been admixed with the digestion composition, the solution is filtered and the filtrate containing the petroleum oil is isolated. This step can be repeated multiple times depending upon the type and amounts of impurities present in the soil sample. The filtration step can be conducted using techniques known in the art. For example, filtration can be performed by the use of standard filter paper (e.g., Whatman size 0.4, 0.6, 0.8, or 1.0 microns depending upon the type of soil in the sample) or a glass-wool filter. After the filtrate has been isolated, it can be further processed (e.g., removal of solvent and/or polysaccharide) or used as-is to evaluate one or more properties of the oil.

### Examples

The following examples are put forth so as to provide those of ordinary skill in the art with a complete disclosure and description of how the systems and methods described and claimed herein are constructed, operated, and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric.

### Chitosan

Shrimp shells were subjected to a process of washing and drying in an oven and they were milled so that smaller particle size is obtained. Once the shrimp shells are in the form of powder, the powder was subjected to deproteinization using 10% sodium hydroxide (w/v) in a ratio of ⅕ per volume with an electric shaker (250 RPM). After two hours at a temperature of 80° C., the powder was filtered, washed with water, then the deproteinization process repeated with 10% NaOH.

Once deproteinized, the product was washed with water until neutral. Then product was treated with 5% hydrochloric acid (v/v) (ratio of ⅕ per volume product to acid) and stirred for two hours at 250 rpm at room temperature. The product was washed, and the process above was repeated with HCl. The product was washed with water to remove any residual acid.

The neutralized product was dried for 18 hours in an oven at 100° C. up to 3% humidity and a 20% performance compound 1. The dried product was subjected to deacetylation using a solution of NaOH 50% with vigorous stirring at 250 rpm for 4 hours at a temperature of 100° C. The ratio of product to NaOH was ⅛ weight to volume. The NaOH solution was removed and the solid washed to remove any base. The product was dried resulting in a performance of 65% with respect to Compound 1. The final chitosan product had a moisture percentage of 1%.

### Preparation of Reactors

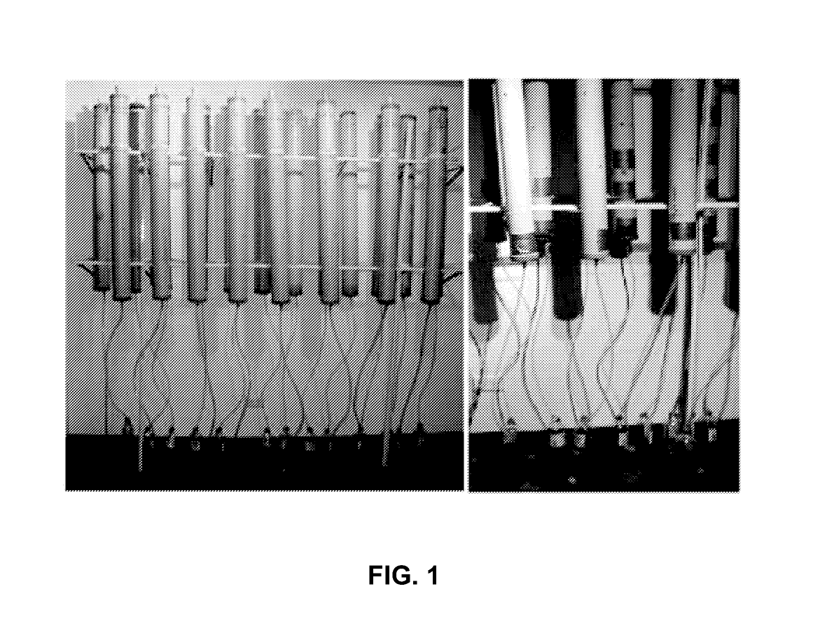

To validate the tests used to assess different types of petroleum, reactors were constructed to simulate the actual behavior of petroleum in the Earth. FIG. 1 depicts exemplary reactors that can be used. Reactor construction proceeded as follows:

Reactors were 30 cm long and 15 cm in diameter. Each reactor contained three orifices where samples could be drawn from the reactors. Reactors were constructed in modular form to allow joining with other reactors so as to lengthen or expand in height the size of the reactors. For example, joining two reactors would create a new reactor that was 60 cm long with six sampling orifices. A distance of 3 cm typically existed between sampling orifices, and sampling orifices had diameters of 1 cm.

Reactors were filled with 3500 g of natural soil. This soil was saturated with 112.5 mL hexane, 112.5 mL dichloromethane, and 45 mL of petroleum hydrocarbons, which resulted in approximately 20% saturation of the soil with hydrocarbons.

After saturating the soil as described above, the reactors were covered and allowed to drain for six days. Next, a total of 18 samples were measured from each reactor (samples were taken from each of 6 different sampling orifices at 3 different times, for a total of 18).

### Sample Preparation

After samples were removed from the reactors, they were prepared for analysis according to the following protocol. A 1 g sub-sample was taken from each sample. 1.5 mL of hexane, 1.5 mL of dichloromethane, 100 μL of polysaccharide solution, and 100 μL of dilute nitric acid were added to each sample. Samples were then homogenized and filtered into a test tube prior to measurement. In another experiment, when ten times the amount of starting materials was used, more accurate results with respect to the determination of the petroleum grade were achieved.

### Results

API gravity of each sample was evaluated using a densitometer and ASTM method D5002 at a laboratory certified for the identification of petroleum. Results for some test samples are presented in Table 1. The results indicate that purity of the petroleum oil isolated from the soil sample was high, as the API gravity values as determined by ASTM D5002 were close to the theoretical values of the pure oil.

TABLE 1
Theoretical Values and ASTM D5002 Values
of API Gravity for Known Samples

| | Theoretical | API Gravity |
|---|---|---|
| Sample | Value | (ASTM D5002) |
| 1 | 9 | 9.9 |
| 2 | 11 | 11.06 |
| 3 | 45 | 44.19 |

What is claimed is:

1. A method for isolating petroleum oil from a soil sample, the method comprising:
a. obtaining a sample comprising petroleum oil;
b. contacting the sample with a digestion composition; and
c. filtering the sample in order to isolate a filtrate, wherein the filtrate comprises the petroleum oil.

2. The method of claim 1, wherein the digestion composition comprises a polysaccharide.

3. The method of claim 1, wherein the digestion composition comprises chitosan.

4. The method of claim 2 or 3, wherein the digestion composition comprises one or more organic solvents.

5. The method of claim 4, wherein the organic solvent comprises a linear or branched hydrocarbon, a halogenated hydrocarbon, or a mixture thereof.

6. The method of claim 1, wherein the digestion composition comprises chitosan, hexane, and dichloromethane.

7. The method of claim 1, wherein the soil sample comprises sandy soil, sludge, clay sediment, silt, sandy sediment, or any combination thereof.

8. A digestion composition comprising chitosan, a linear or branched hydrocarbon, and a halogenated hydrocarbon.

9. A digestion composition comprising chitosan, hexane, and dichloromethane.
